(19) United States
(12) Patent Application Publication
(10) Pub. No.: US 2013/0309963 A1
(43) Pub. Date: Nov. 21, 2013

(54) VIBRATION ENCODED PARENT-TO-CHILD REMOTE COMMUNICATION SYSTEM

(71) Applicant: Sigal SHASHA, Zur Moshe (IL)

(72) Inventor: Sigal SHASHA, Zur Moshe (IL)

(21) Appl. No.: 13/475,991

(22) Filed: May 20, 2012

(51) Int. Cl. H04B 7/26

(52) U.S. Cl. 455/39

(57) ABSTRACT

A vibration encoded parent-to-child remote communication system and a method for remote vibration encoded parent-to-child communication are disclosed. The parent to child vibration encoded remote communication system includes a parent device, configured to transmit and receive wireless communication signals, and a child device, configured to receive and transmit wireless communication signals. At least the child's device includes further at least one multi mode vibration generator wherein the parent-to-child messages, wirelessly transmitted to the child's device, encode vibration modes that are communicated to the child by the provided multi mode vibration generator.

### FIELD OF THE INVENTION

The invention relates generally to parent-to-child remote communication systems, and more particularly, the present invention relates to a vibration encoded parent-to-child and child-to-parent remote communication system.

### BACKGROUND OF THE INVENTION

The present invention provides a parent to child remote communication system that transmits pre-set vibration encoded messages which is easy to generate at the transmitter side and easy to notice and interpret at the receiver side.

U.S. Pat. No. 6,826,120 entitled “a child's wristwatch type communication device” discloses a child's wristwatch type device featuring simple safety and security communication capability. The disclosed device allows the child to call one of several preset numbers with a single push of a button, thereby providing peace of mind for both parents and child. The invention includes a wireless telephone means and a small speaker.

US Patent application 2004/0214568 entitled “Remote Ultrawide Band Communication System with Short Messaging and Other Functions” discloses a wireless communication system especially suitable for children which utilizes ultra wide band (UWB) forward, internet protocol messaging (IPv6) and cellular communication technologies. The disclosed system eliminates the child's need to know or dial telephone numbers, e-mail addresses or the like.

US Patent application 2010/0214093 entitled “Wireless Messaging System for Parents and Children” discloses a wireless messaging system for use in sending discrete messages between a parent and child. A master (parent) unit has a plurality of pre-set messages that can be sent by radio transmission to the remote (child) unit. The remote unit will activate the appropriate message as a visual indication on the face of the remote unit. The remote unit may have visual, audible or vibratory alarms activated in the event a “Help” button is depressed.

The cited documents herein above do not disclose a vibration encoded parent-to-child remote communication system that include a multi mode vibration generator used to generate pre-set vibration modes that encode parent-to-child and child-to-parent pre-set messages.

It would be highly advantageous to provide a vibration encoded parent-to-child and child-to-parent remote communication system used to transmit pre-set vibration encoded messages which is easy to generate, easy to notice and easy to interpret by both children and parents.

### SUMMARY OF THE INVENTION

A vibration encoded parent-to-child remote communication system and a method for remote vibration encoded parent-to-child communication are disclosed. The parent to child vibration encoded remote communication system includes a parent device, configured to transmit and receive wireless communication signals, and a child device, configured to receive and transmit wireless communication signals. At least the child's device includes further at least one multi mode vibration generator wherein the parent-to-child messages, wirelessly transmitted to the child's device, encode vibration modes that are communicated to the child by the provided multi mode vibration generator.

According to a further feature of an embodiment of the present invention, the parent device comprises further at least one multi mode vibration generator wherein child-to-parent messages wirelessly transmitted from the child's device to the parent's device encode vibration modes communicated to the parent by the provided multi mode vibration generator.

According to a further feature of an embodiment of the present invention, the child's device configured to receive and transmit wireless communication signals may be a watch-like device adapted to be mounted on the child's wrist.

According to a further feature of an embodiment of the present invention, the parent device configured to receive and transmit wireless communication signals may be a watch-like device adapted to be mounted on the parent's wrist.

According to a further feature of an embodiment of the present invention, the multi mode vibration generator transforms wireless communication signals received from the parent device into a set of pre-set vibration modes communicated to the child's wrist by the child's watch-like device.

According to a further feature of an embodiment of the present invention, the set of pre-set vibration modes comprises vibrations with various frequencies, amplitudes and vibration sequences having various numbers of pulses and time delays between the pulses in the encoded vibration modes.

According to a further feature of an embodiment of the present invention, each of the devices comprises two or more multi mode vibration generators such that combinations of vibration modes are used to encode the parent-to-child and child-to-parent messages.

According to a further feature of an embodiment of the present invention, each of the child and parent devices comprises further a set of buttons used to generate each of the encoded wireless communication signals by one button touch.

According to a further feature of an embodiment of the present invention, the device buttons may have different shape designs and Braille dots such that blind people can distinguish between buttons.

According to a further feature of an embodiment of the present invention, the parent-to-child and child-to-parent devices further comprise respective memories for storing pre-set encoding vibration modes from among which the parent-to-child and child-to-parent vibration encoded modes are to be selected.

According to a further feature of an embodiment of the present invention, the parent and child devices comprise further visual means for displaying visual messages that accompany at least one of the parent-to-child or child-to-parent vibration encoded messages.

According to a further feature of an embodiment of the present invention, the visual messages include various light colors and light pulse sequences.

According to a further feature of an embodiment of the present invention, the parent and child devices comprise further audible means for displaying audible messages that accompany at least one of the parent-to-child or child-to-parent vibration encoded messages.

According to a further feature of an embodiment of the present invention, the audible means accompanying the encoded vibration messages include speaker devices configured to generate pre-set sounds.

According to a further feature of an embodiment of the present invention, the audible means accompanying the vibration encoded messages comprise further a recording means that allow recording short audible messages to be transmitted accompanying the received vibration encoded messages.

According to a further feature of an embodiment of the present invention, a method for remote parent-to-child and child-to-parent communication is disclosed. The method includes the steps of (a) providing a vibration encoded remote parent-to-child and child-to-parent communication system comprising parent and child devices wherein at least the child's device comprises further a multi mode vibration generator, (b) mounting the child's device on the child's wrist, (c) pressing buttons on the parent device transmitting the parent-to-child vibration encoded message to the child device, (d) communicating the selected pre-set vibration mode to the child using the provided multi mode vibration generator.

According to a further feature of an embodiment of the present invention, the parent's device includes at least one multi mode vibration generator and the method includes further the steps of pressing buttons on the child's device transmitting the child-to-parent vibration encoded message to the parent's device, and communicating the selected pre-set vibration mode to the parent using the provided multi mode vibration generator.

According to a further feature of an embodiment of the present invention, the method includes further the step of selecting a pre-set encoded vibration mode for each parent-to-child and child-to-parent messages from provided pre-set vibration modes.

According to a further feature of an embodiment of the present invention, the method includes further the step of accompanying the encoded vibration modes with visual signals.

According to a further feature of an embodiment of the present invention, the method includes further the step of accompanying the encoded vibration modes with audible signals.

According to a further feature of an embodiment of the present invention, the parent devices may be used by care giving institution employees and the child devices may be used by the care giving institution care recipients to transmit and receive vibration encoded messages.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 illustrates schematically a parent-to-child remote communication system, according to an embodiment of the present invention;

FIG. 2 illustrates a parent-to-child and a child-to-parent remote communication system, according to an embodiment of the present invention;

FIG. 3a illustrates a child device with additional visual means, according to an embodiment of the present invention;

FIG. 3b illustrates an expanded view of revolving visual means, according to an embodiment of the present invention;

FIG. 4 illustrates a parent device with additional visual and audible means, according to an embodiment of the present invention;

FIG. 5 illustrates a vibration mode as a sequence of pulses with fixed amplitude and fixed time delays between pulses, according to an embodiment of the present invention;

FIG. 6a-b illustrates two vibration modes having different pulse amplitudes, according to an embodiment of the present invention;

FIG. 7a-b illustrates two vibration modes having different numbers of pulses in each pulse sequence and different time delays between pulses, according to an embodiment of the present invention;

FIG. 8a-b illustrates two vibration modes having different numbers of pulses in each pulse sequence, different time delays between pulses and varying amplitude in each sub sequence, according to an embodiment of the present invention;

### DETAILED DESCRIPTION OF THE PREFERRED EMBODIMENTS

A vibration encoded parent-to-child and child-to-parent remote communication system and a method for parent-to-child and child-to-parent remote communication are disclosed. The vibration encoded remote communication system includes a parent's device configured to transmit and receive wireless communication radio frequency signals and a child's device configured to receive and transmit wireless communication radio frequency signals. Various vibration modes are used to encode parent-to-child and child-to-parent messages wirelessly transmitted wherein at least the child's device comprises further at least one multi mode vibration generator used to communicate to the child the vibration encoded messages generated by the provided multi mode vibration generator.

According to embodiments of the present invention, vibrations transmitted to the child's wrist are the most effective and detectable means for transmitting wireless communication messages and catching the child's attention, more effective than sensing signals with other human senses such as hearing and/or seeing since in a crowded place, visual and audible signals might be undetected, lost and unseen by the child while vibrations transmitted directly to the child's wrist will be felt and will catch the child's attention immediately.

According to embodiments of the present invention, the parents' and the child's devices, configured to receive and transmit wireless communication signals, may be watch-like devices mounted on the parents' and child's wrists, a key's holder carried by the parent in his pocket, a necklace and the like. Other devices and device shapes may be used as the parents' and the child's devices and are in the scope of the present invention.

According to a further aspect of the present invention, certain embodiments provide a method for parent-to-child and child-to-parent vibration encoded remote communication. The method includes the steps of (a) providing a vibration encoded remote parent-to-child and child-to-parent communication system comprising parent and child devices wherein at least the child's device comprises further a multi mode vibration generator, (b) mounting the child's device on the child's wrist and (c) pressing buttons on the parent's device transmitting the parent-to-child vibration encoded message to the child device and (d) communicating the selected pre-set vibration mode to the child using the provided multi mode vibration generator.

The method for vibration encoded parent-to-child and child-to-parent remote communication may further include the step of (e) pressing buttons on the child's device transmitting child-to-parent vibration encoded message to the parent's device, and (f) communicating the selected pre-set vibration mode to the parent using a provided multi mode vibration generator included in the parent's device.

According to embodiments of the present invention, the vibration encoding of the wireless communicated signal may include transmission of radio frequency signals modulated with the selected vibration mode and may include further transmission of radio frequency signal modulated with a digital code. The digital code is decoded in the receiver device that looks up in the receiver's memory a pre-defined vibration sequence associated with the digital code to be generated by the vibration generator and communicated to the child or his parents.

According to embodiments of the present invention, the vibration encoded remote communication method includes further the step of selecting a pre-set encoded vibration mode for each parent-to-child and child-to-parent message from pre-set vibration modes provided with the parents' and child's devices. The vibration encoded remote communication method may include further the step of accompanying the encoded vibration signals with visual and/or audible signals.

According to embodiments of the present invention, the words “parent” and “child” may be understood in a broader sense, where “parent” may be understood as a care giver person and the word “child” may be understood as the care receiving person. Thus, the vibration encoded parent-to-child and child-to-parent remote communication system may be used for a vibration encoded remote communication between any two people who care for each other, friends, neighbors and family members for example.

According to embodiments of the present invention, the vibration encoded parent-to-child and child-to-parent remote communication system may be given as a gift to a care receiving person from a care giving person.

According to embodiments of the present invention, the vibration encoded parent-to-child and child-to-parent remote communication system may be used to communicate also an emergency alert messages by one touch in case of dangerous situations, such as during home break-ins, robbery, rape and/or medical emergency.

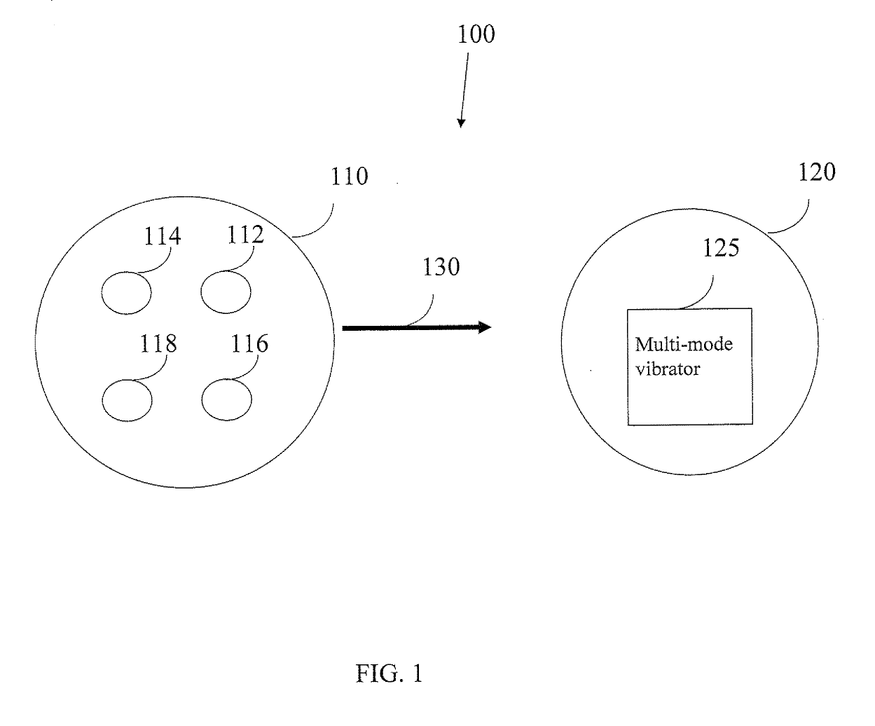

FIG. 1 illustrates schematically a parent-to-child remote communication system 100, according to an embodiment of the present invention. Parent device 110 includes means for transmitting wireless signals. The transmitted wireless signals 130 encode vibration modes. Pressing each of the 4 buttons, 112, 114, 116 and 118 illustrated in parent device 110 generates and transmits a specific pre-set wireless signal. Child device 120 includes a wireless signal receiver (not shown) and at least one multi mode vibration generator 125. The multi mode vibration generator 125 transforms the received wireless signals into pre-selected vibration modes transmitted to the child's wrist.

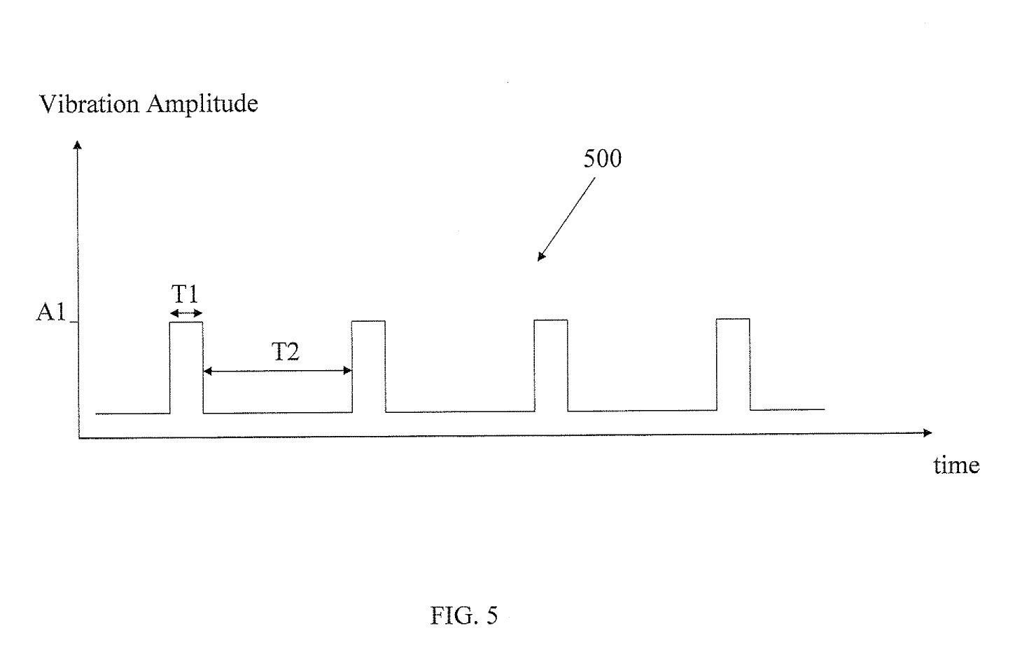

Parent-to-child messages that may be encoded for example may be “stop!”, “look at me!”, “come home!” and “good!” The child that wears the watch-like parent-to-child vibration encoded remote communication system of the present invention, receives the various vibration modes and learns to interpret them easily as selected by the parent and the child. Messages like “stop!”, “look at me!”, “come home!”, “I want to talk with you” and “good!” may be encoded in various vibration modes illustrated herein below in FIGS. 5-8 in non limiting example.

According to embodiments of the present invention, the multi mode vibration generator transforms wireless communication signals received from the parent device into a set of pre-set specific vibration modes transmitted to the child's wrist by the child's watch-like device. The set of pre-set specific vibration modes may comprise vibrations with various frequencies, amplitudes and sequences having various numbers of pulses, pulse durations and time delays between pulses. Few examples of vibration modes that may be pre-set are illustrated in FIGS. 5-8 herein below.

According to embodiments of the present invention, the watch-like device may include two or more multi mode vibration generators such that combinations of vibration modes may be used to communicate the parent-to-child and child-to-parent encoded messages.

According to embodiments of the present invention, other messages and any number of pre-set messages may be provided within the parents' and child's devices, may be selected by the parent and the child and such selected sets of provided vibrations modes associated with pre-set parent-to-child and child-to-parent messages are in the scope of the present invention.

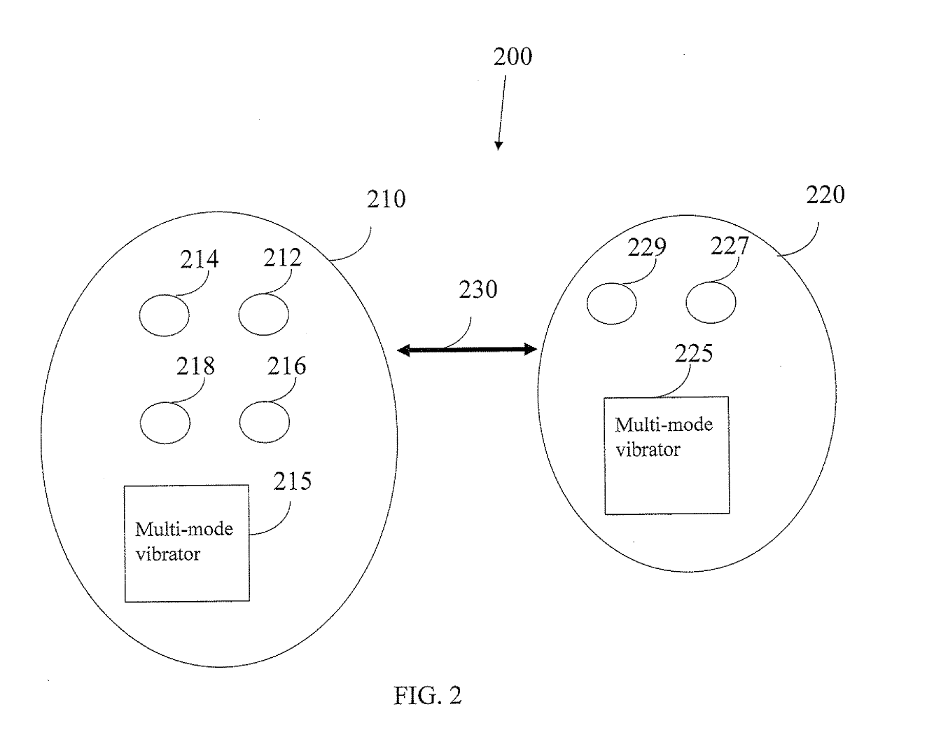

FIG. 2 illustrates a parent-to-child and a child-to-parent remote communication system 200, according to an embodiment of the present invention. Parent device 210 includes means for transmitting wireless signals and at least one multi mode vibration generator 215. Transmitted wireless signals 230 encode various parent-to-child and child-to-parent messages. Pressing each one out of the 4 buttons illustrated, 212, 214, 216 and 218 in parent device 210 generates and transmits a pre-selected wireless signal. Child device 220 includes a wireless signal receiver (not shown), at least one multi mode vibration generator 225 and means for transmitting wireless signals to the parent device triggered by pressing buttons 227 and 229. Multi mode vibration generators 125 and 225 transform the received wireless communication signals to specific pre-selected vibration modes.

According to embodiments of the present invention, the child-to-parent messages may be for example “OK”, “I see you”, “I am coming home”, “kiss”, “please come home”, “help me!” and “where are you?” Other child-to-parent messages may be used and are in the scope of the present invention.

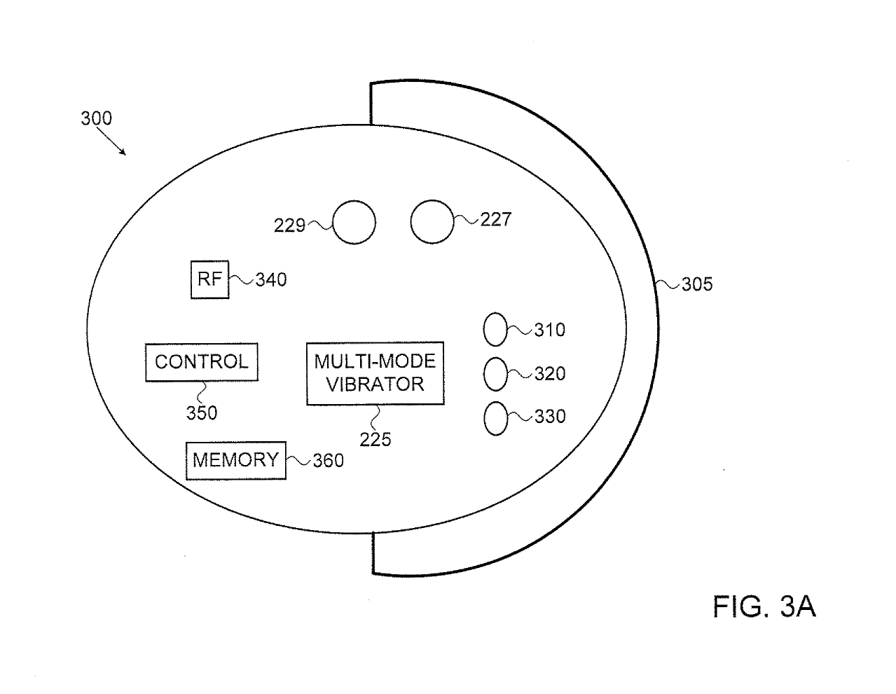

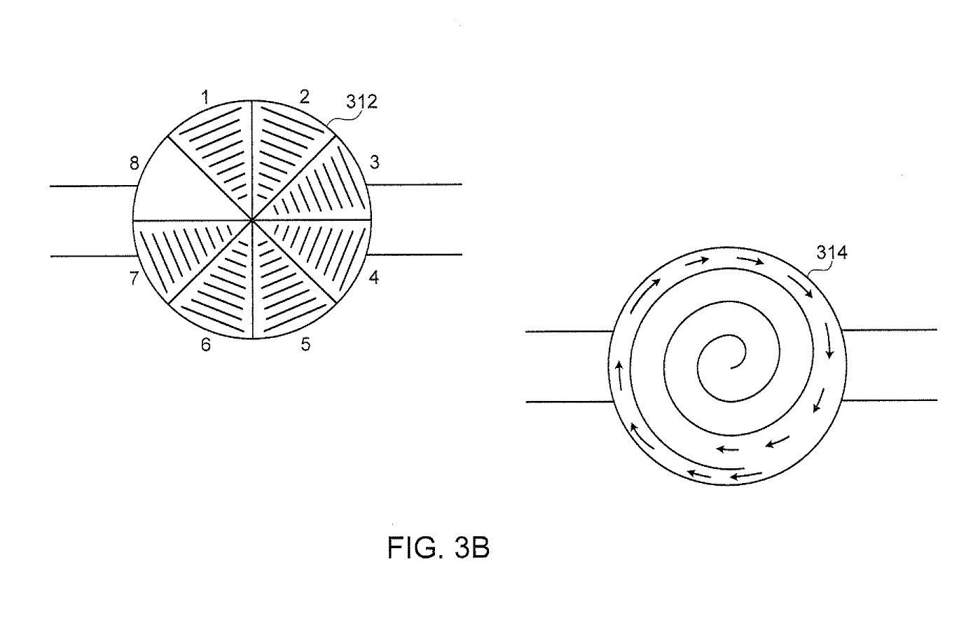

FIG. 3a illustrates a child device with additional visual means, according to an embodiment of the present invention. Child device 300 may include a watch band 305, at least one multi mode vibration generator 225, RF transceiver 340 used to transmit wireless signals to the parent device (and receive wireless signals from the parent device) activated by control unit 350 triggered by buttons 227 and 229, visual means for displaying visual messages such as miniature light bulbs 310, 320 and 330. Miniature light bulbs 310, 320 and 330 may have red, green and blue colors for example. A vibration mode may be accompanied by a light bulb blink used to enhance the impact of the message on the receiver side. Any combination of pre-selected vibration mode accompanied by displaying visual signal may be selected and the parent and the child may learn to remote communicate using the vibration encoded messages accompanied by the visual means displaying enhancement. Child device 300 may include a memory 360 used to store the provided set of vibration modes that may be selected by the parent and the child to encode messages.

FIG. 3b illustrates an expanded view of revolving visual means, according to an embodiment of the present invention. Child device 300 (illustrated in FIG. 3a) visual means 310, 320 and 330 may include further revolving members 312 and 314 mounted on the device front face. The combined effect of revolving members 312 and 314 and colored light or colored light pulses that accompany a received vibration encoded message increases the detectability of the received message.

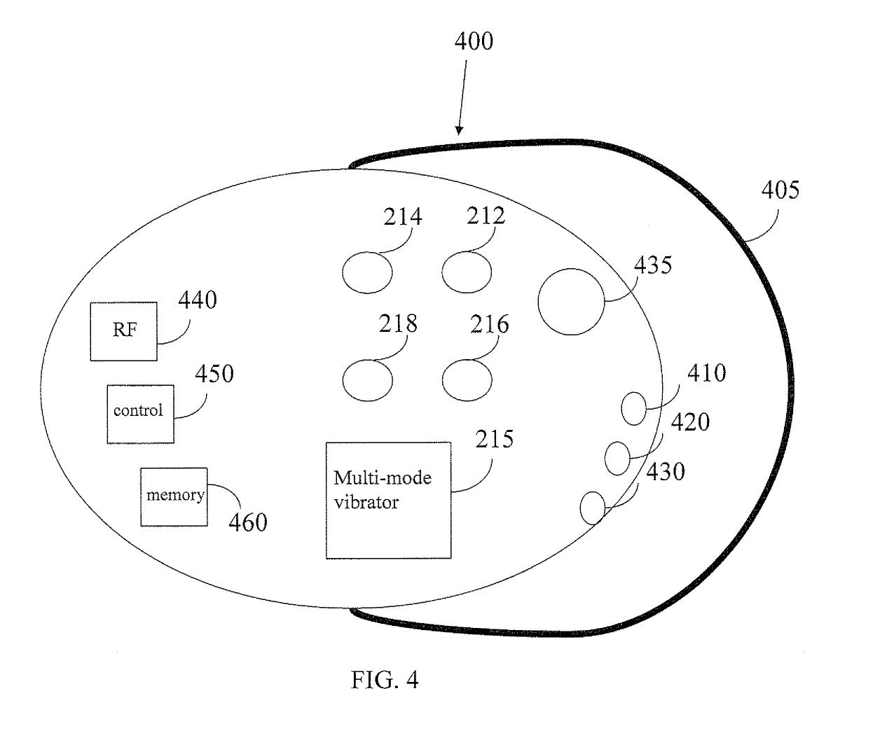

FIG. 4 illustrates a parent device with additional visual and audible means, according to an embodiment of the present invention. Parent device 400 may include a watch band 405, at least one multi mode vibration generator 215, RF transceiver 440 used to transmit and receive wireless signals activated by control unit 450 triggered by buttons 212, 214, 216 and 218, miniature light bulbs 410, 420 and 430 and audible means 435 for displaying audible messages. Audible means 435 may be a speaker used to accompany the pre-selected generated vibration modes with audible message to enhance the impact of the vibration encoded message received. The pre-set audible messages accompanying the encoded vibration messages may include recorded words and sentences. Parent device 400 may include a memory 460 used to store the provided set of vibration modes that may be selected by the parent and the child to encode messages.

According to embodiments of the present invention, the device may include recording means such that short audible messages with the parent voice may be recorded in the child's device and transmitted accompanying specific vibration encoded message.

FIG. 5 illustrates a vibration mode as a sequence of pulses with fixed amplitude and fixed time delays between pulses, according to an embodiment of the present invention. A vibration mode may include 4 equal vibration pulses in a sequence, with amplitude A1, pulse duration T1 and with T2 time delay between the vibration pulses. T1, T2 and A1 may be constant pre-programmed values or programmable values of the multi mode vibration generator (FIG. 4 215). Any number of pulses in a vibration mode may be used according to embodiments of the present invention.

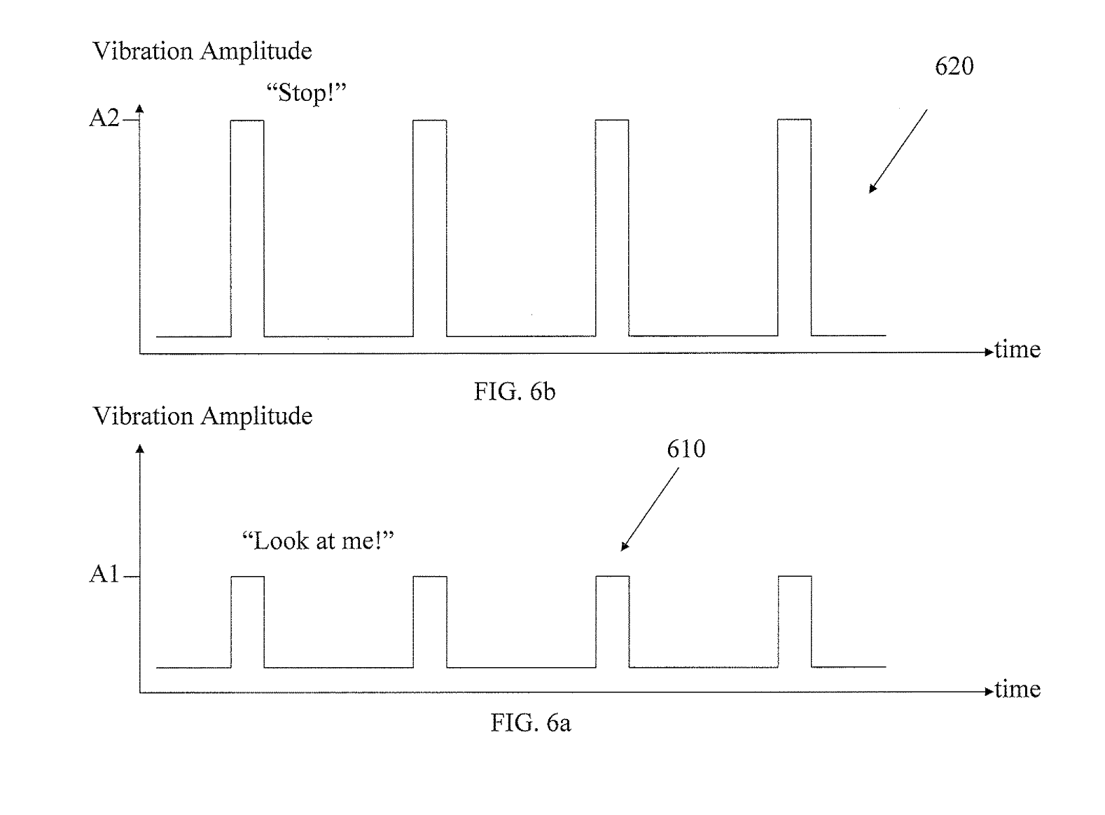

FIG. 6a-b illustrates two vibration modes having different pulse amplitude, according to an embodiment of the present invention. FIG. 6a illustrates a vibration mode 610 that may be interpreted as the parent-to-child message “Look at me!” FIG. 6b illustrates a vibration mode 620 comprised of higher amplitude pulses and same pulse duration, pulse number and time delay between pulses as shown in FIG. 6a. The vibration mode 620 may be the parent-to-child message “stop!”

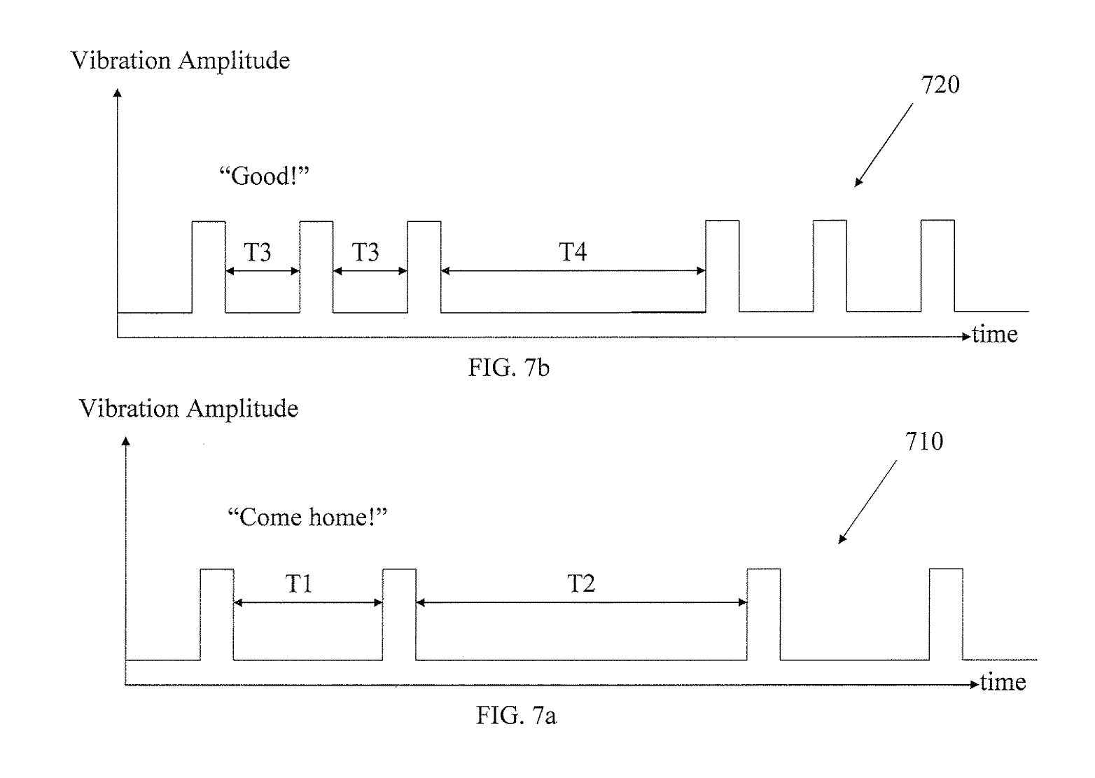

FIG. 7a-b illustrates two vibration modes having different numbers of vibration pulses in each pulse sequence and different time delays between pulses, according to an embodiment of the present invention. FIG. 7a illustrates a vibration mode 710 that may be interpreted as the parent-to-child message “Come home!” vibration mode 710 includes a repeated sequence of two pulses of the same amplitude having time delay between pulses T1. The time delay between repeated sequences is T2.

FIG. 7b illustrate a vibration mode 720 that includes a repeated sequence of three pulses with the same amplitude having a time delay between pulses T3 and a time delay between sub pulse sequence of T4. The vibration mode 720 may be the parent-to-child message “Good!” for example.

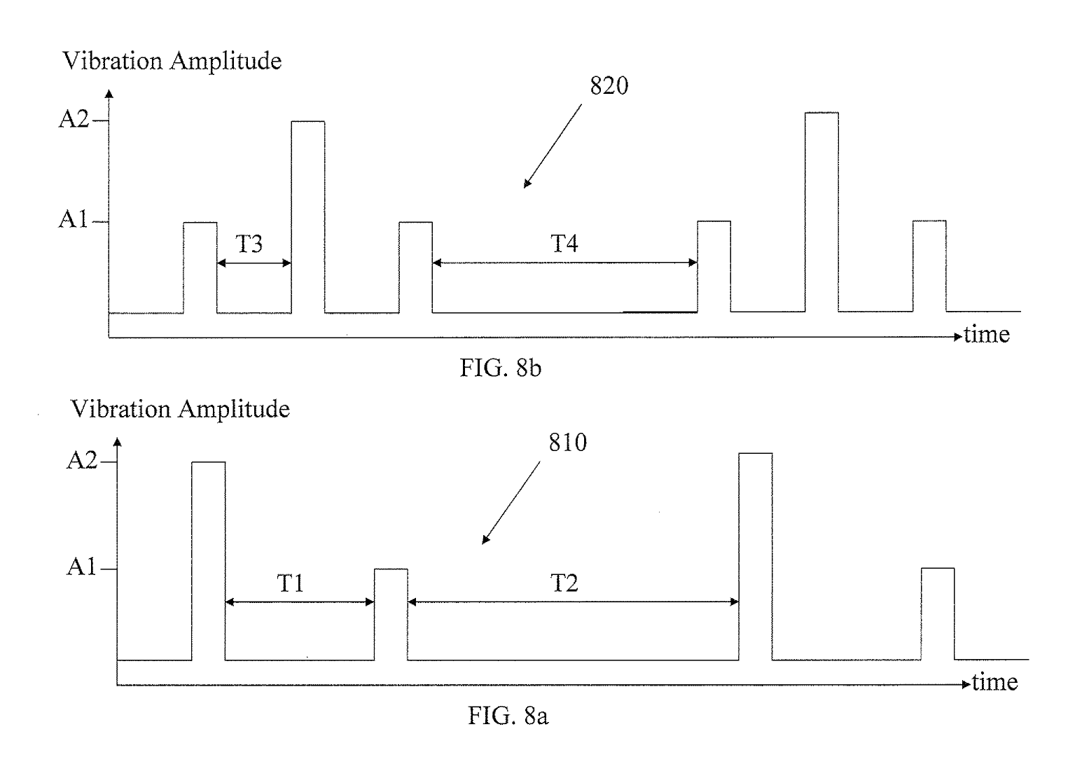

FIG. 5a-b illustrates two vibration modes having different numbers of pulses in each pulse sequence, different delays between pulses and varying amplitude in each sub sequence, according to an embodiment of the present invention. FIG. 8a illustrates a vibration mode 810 that includes a repeated sequence of two pulses with varying amplitudes A1 and A2 having a time delay between pulses T1. The time delay between repeated sequences is T2.

FIG. 8b illustrates a vibration mode 820 that includes a repeated sequence of three pulses having varying amplitudes and having a time delay between pulses T3 and a time delay between pulse sequences T4. The vibration modes 810 and 820 may be used as one of the stored parent-to-child or child-to-parent messages.

The vibration modes illustrated in FIGS. 5-8 are examples of possible vibration modes that may be stored in the parent and child devices and may be selected by the parent as a message to the child. The parent may teach his child to identify and associate the pre-selected vibration mode with messages such as “stop!”, “look at me!”, “come home!” and “good!”.

According to embodiments of the present invention, the parent-to-child remote communication system may be a waterproofed device allowing usage of the remote communication system also in swimming pools, beaches and the like.

According to embodiments of the present invention, the parent-to-child message may be received by a group of children allowing the parent (or teacher) to instruct and receive messages from groups of children where such message might be for example “return to the bus” in a school fieldtrip etc.

According to embodiments of the present invention, the parent-to-child vibration encoded remote communication system may be used to remotely communicate with the blind and/or the deaf and/or the mute. The vibration encoded messages may be easily received and interpreted by the blind and/or the deaf and/or the mute that may communicate messages with each other and with their parents or teachers easily and conveniently. According to embodiments of the present invention, the parent-to-child vibration encoded remote communication system adopted to the blind may include an advanced set of messages that will assist blind people to communicate with others with the intuitive, easy to generate and easy to interpret vibration encoded messaging system. Accordingly, buttons 227 and 229 for example (shown in FIG. 3a) may have different shapes and/or a Braille dots such that the blind will be able to distinguish the different buttons and select and transmit the message they want to communicate.

According to embodiments of the present invention, the parent-to-child vibration encoded remote communication system may be used to transmit and receive vibration encoded messages in care giving institutions where the parent devices may be used by the care giving institution employees and the child devices may be used by the institution care recipients. The care giving institutions may be for example schools, hospitals, homes for elderly people, care giving institutions for the blind, for the deaf and for the mute.

According to embodiments of the present invention, the child device may include further a GB antenna such that the position of the child device may be transmitted to the parent device by pressing a button on the child device.

Advantageously, the present invention parent-to-child vibration encoded remote communication system may be used to encode parent-to-child and child-to-parent messages in vibration modes wirelessly transmitted between a parent and a child devices.

Another advantage of the parent-to-child vibration encoded remote communication system described above is that the vibration modes are intuitive, easy to learn such that young children may learn to interpret and act according to the parent-to-child messages and to transmit the appropriate child-to-parent message in response.

Another advantage of the parent-to-child vibration encoded remote communication system described above is that encoded vibration modes are the most effective and attention catching remote communication means and the vibration encoded messages may be accompanied further by visual and audible signals.

Another advantage of the parent-to-child vibration encoded remote communication system described above is that a caregiver can buy the vibration encoded remote communication system as a gift to a person he cares for.

Another advantage of the parent-to-child vibration encoded remote communication system described above is that more than one multi modes vibration generator may be used in a single device increasing the number of vibration modes that may be provided and the impact of the received message.

Furthermore, the present invention parent-to-child vibration encoded remote communication system allows silent, fast and intuitive message communication between a parent and a child over distances that may be crowded with people and without line of sight.

In summary, the parent-to-child remote vibration encoded communication system of the present invention improves the prior art proposed parent-to-child wireless communication systems by introducing pre-set encoded vibration modes wirelessly transmitted between parent and child devices, and wherein the encoded vibration modes are easy to learn and interpret by young children and their parents.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description. While preferred embodiments of the present invention have been shown and described, it should be understood that various alternatives, substitutions, and equivalents can be used, and the present invention should only be limited by the claims and equivalents thereof.

What is claimed is:

1. A parent-to-child remote communication system, the system comprising:
a parent device configured to transmit and receive wireless communication signals; and
a child device configured to receive and transmit wireless communication signals and comprising further at least one multi mode vibration generator,
wherein said parent-to-child messages wirelessly transmitted encode vibration modes communicated to the child by the provided multi mode vibration generator.

2. The parent to child remote communication system according to claim 1, wherein said parent device comprises further at least one multi mode vibration generator wherein child-to-parent messages wirelessly transmitted from the child's device to the parent's device encode vibration modes communicated to the parent by said provided multi mode vibration generator.

3. The parent to child remote communication system according to claim 1, wherein said child's device configured to receive and transmit wireless communication signals is a watch-like device adapted to be mounted on the child's wrist.

4. The parent to child remote communication system according to claim 1, wherein said parent device configured to receive and transmit wireless communication signals is a watch-like device adapted to be mounted on the parent's wrist.

5. The parent to child remote communication system according to claim 3, wherein said multi mode vibration generator transforms wireless communication signals received from the parent device into a set of pre-set vibration modes communicated to the child's wrist by said child's watch-like device.

6. The parent to child remote communication system according to claim 1, wherein said set of pre-set vibration modes comprises vibrations with various frequencies, amplitudes and vibration sequences having various numbers of pulses and time delays between said pulses in said encoded vibration modes.

7. The parent to child remote communication system according to claim 2, wherein each said devices comprises two or more multi mode vibration generators such that combinations of vibration modes are used to encode the parent-to-child and child-to-parent messages.

8. The parent to child remote communication system according to claim 2, wherein each of said child and parent devices comprises further a set of buttons used to generate each of said encoded wireless communication signals by one button touch.

9. The parent to child remote communication system according to claim 8, wherein said device buttons have different shape designs and Braille dots such that blind people can distinguish between buttons.

10. The parent to child remote communication system according to claim 2, wherein said parent-to-child and child-to-parent devices further comprise respective memories for storing pre-set encoding vibration modes from among which said parent-to-child and child-to-parent vibration encoded modes are to be selected.

11. The parent to child remote communication system according to claim 1, wherein said parent and child devices comprise further visual means for displaying visual messages that accompany at least one of said parent-to-child or child-to-parent vibration encoded messages.

12. The parent to child remote communication system according to claim 11, wherein said visual messages include various light colors and light pulse sequences.

13. The parent to child remote communication system according to claim 2, wherein said parent and child devices comprise further audible means for displaying audible messages that accompany at least one of said parent-to-child or child-to-parent vibration encoded messages.

14. The parent to child remote communication system according to claim 13, wherein said audible means accompanying said encoded vibration messages include speaker devices configured to generate pre-set sounds

15. The parent to child remote communication system according to claim 14, wherein said audible means accompanying said vibration encoded messages comprise further a recording means that allow recording short audible messages to be transmitted accompanying said received vibration encoded messages.

16. A method for remote parent-to-child and child-to-parent communication, the method comprises the steps of:
providing a vibration encoded remote parent-to-child and child-to-parent communication system comprising parent and child devices wherein at least said child's device comprises further a multi mode vibration generator;
mounting said child's device on the child's wrist; and
pressing buttons on said parent device transmitting said parent-to-child vibration encoded message to the child device,
communicating the selected pre-set vibration mode to the child using said provided multi mode vibration generator.

17. The method for remote parent-to-child communication according to claim 16, wherein said parent's device comprises at least one multi mode vibration generator and wherein the method comprises further the steps of:
pressing buttons on said child's device transmitting said child-to-parent vibration encoded message to the parent's device; and
communicating the selected pre-set vibration mode to the parent using said provided multi mode vibration generator.

18. The method for remote parent-to-child communication according to claim 16, comprising further the step of selecting a pre-set encoded vibration mode for each parent-to-child and child-to-parent messages from provided pre-set vibration modes.

19. The method for remote parent-to-child communication according to claim 16, comprising further the step of accompanying said encoded vibration modes with visual signals.

20. The method for remote parent-to-child communication according to claim 16, comprising further the step of accompanying said encoded vibration modes with audible signals.

21. The method for remote parent-to-child communication according to claim 17, wherein said parent devices are used by care giving institution employees and said child devices are used by said care giving institution care recipients to transmit and receive vibration encoded messages.
